(19) United States
(12) Patent Application Publication
(10) Pub. No.: US 2009/0081606 A1
(43) Pub. Date: Mar. 26, 2009

(54) DENTAL MATRIX BAND HOLDER AND PROCEDURE

(76) Inventor: ROBERT M. SCARAZZO, DOYLESTOWN, PA (US)

Correspondence Address: GREGORY J. GORE, 70 WEST OAKLAND AVENUE, SUITE 316, DOYLESTOWN, PA, 18901, US

(21) Appl. No.: 11/861,566

(22) Filed: Sep. 26, 2007

(51) Int. Cl. A61C 5/04

(52) U.S. Cl. 433/39

(57) ABSTRACT

A matrix band holder includes contour surfaces on the clamphead corresponding to a pre-contoured matrix band so that the concave shape of the band is maintained as it is tightened against the tooth. The clamp further includes a tethered outward-tension horseshoe-shaped spring with downward-facing perpendicular ends that force the band into contact with adjacent teeth, thus facilitating tight proximal contact of dental restorations.

### FIELD OF THE INVENTION

The present invention relates to dental matrix holders and procedures using dental matrix bands which are positioned around a preparation to create a form for the filling material in restoring a human tooth. The invention also relates to a procedure for using a matrix band holder.

### BACKGROUND OF THE INVENTION

Currently when placing large complex Class II resin restorations, practitioners are faced with the choice of using either 1) a traditional Toffelmier Matrix that gives better isolation from blood and saliva but when fully tightened actually pulls the resin away from the proximal tooth, thus creating an open contact which can be a food trap at best and potentially the cause of additional decay and or periodontal pathology, or 2) a bi-tine ring and sectional matrix that gives much better contacts and contours but is much harder to isolate for successful bonding and is useless if a cusp is missing. Thus, there is a dilemma faced by practitioners whether to choose better isolation at the expense of ideal contacts when placing large Class II restorations, where either or both proximal surfaces are involved in conjunction with the aforementioned operative complications.

There is therefore a need in the art for a matrix system which enables the practitioner to form ideal Class II restorations, especially in difficult situations using traditional Toffelmier technique, but which provides better results in proper heights of contour and proximal contact and contour than presently available. Further, there is a need for a dental matrix system which is designed specifically for large, complex Class II resin restorations needing tight proximal contact and ideal contours, especially where a cusp is missing, there is excessive facial/lingual loss of tooth structure and/or where the proximal box drops subgingival.

### SUMMARY OF THE INVENTION

In order to fulfill the needs in the art explained above, the present dental matrix system has been devised. The problems described above have been overcome by providing superior isolation, proper height of contour facially and lingually, and tight proximal contacts. These attributes are achieved by an S-shaped, pre-contoured matrix band that is complemented by a correspondingly contoured matrix holder. The apparatus further includes a unique tethered, outward-tensioned horseshoe spring, with downward-facing perpendicular ends that force the band into contact with adjacent teeth, thus facilitating tight proximal contact of the dental restorations. This spring is self centering, with adequate leeway on the tether to allow band and matrix placement in all four posterior quadrants with access and placement possible from either left or right operative fields.

The present invention uses the traditional Toffelmier technique with these two unique structures more specifically described as follows: First, the clamphead is concavely contoured on both sides where it addresses the tooth and matrix band. The base is slightly wider than the top like a trapezoid with concave sides. The wider portion is always facing toward roots and away from biting surfaces. See FIG. 3. When the band is tightened, this drives the pre-curved matrix band into the tooth accentuating the convexity and bulbous nature in natural teeth in the newly formed resin restorations. This ensures proper heights of contour and ideal inter proximal contact with adjacent teeth when performing Class II resin cavity restorations. The band and retaining Toffelmier are both contoured and curved in the same manner with complementary dimensions.

Secondly, the present device utilizes a C-shaped expansion spring with downward facing spade-shaped tines at the ends. Unlike prior art spring devices of this type, the present spring supplies an outward or expansionary force rather than an inward or compressive force. The spring is C-shaped with tines that are spade-shaped facing downward. The spring is secured to the clamp by a tether so that it can be swiveled for use in all quadrants of the mouth or placed outside of the mouth if not needed at all. It is also permanently fixed to the Toffelmier block to prevent aspiration or swallowing and to free up one hand of the operator to make his/her work more efficient.

The present device provides many advantages over presently available dental matrix devices which can be problematic as described above. Current offerings have a flat clamphead that addresses the tooth so when it is tightened it actually uncurves and flattens out any pre-shaped curvature of matrix bands. Also, no other dental matrix system has a built-in outward tension spring that acts like a contact instrument. This further enables the operator to gain tight proximal contacts when there is excessive space between teeth or excessive loss of tooth structure.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

Other objects and advantages of the invention will be apparent to those of skill in the art from the following drawings and description of the preferred embodiment.

### BRIEF DESCRIPTION OF THE DRAWINGS

FIG. 1 is a top right front isometric view of the matrix band holder of the invention.

FIG. 2 is a front view of the curved matrix band for use with the holder of the invention, as shown in FIG. 1.

FIG. 3 is a top left front isometric view of the matrix band holder of the invention in use during the first steps in the procedure of its use.

FIG. 4 is a top left front isometric view of the matrix band holder of the invention in use during the subsequent steps in the procedure of its use.

FIGS. 5 and 6 are top views of the final steps in the procedure of the dental band holder of the invention completing the procedure following the steps depicted in FIGS. 3 and 4.

### DESCRIPTION OF THE PREFERRED EMBODIMENT

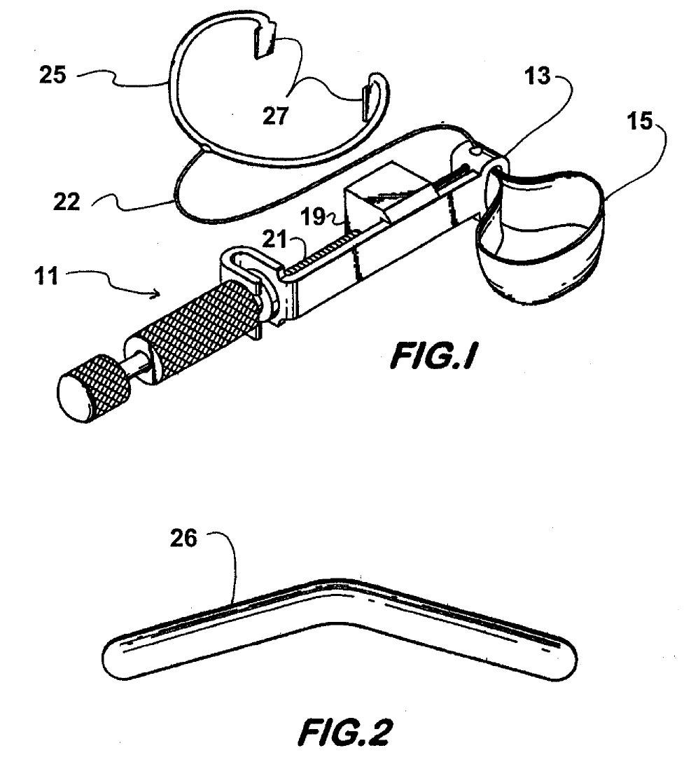

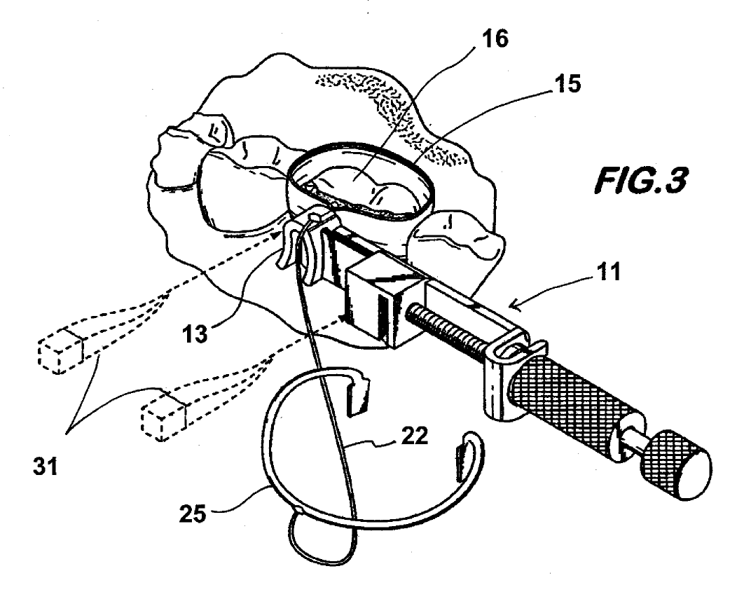

Referring now to FIG. 1, the present invention is shown ready for use. A Toffelmier-type matrix band holder (11) includes a band clamping head (13) which receives the ends of a flexible matrix band (15). The Toffelmeir-type holder has a holding block (19) that cooperates with screw means (21) to effect the tightening of the matrix band. Adjustment screw means (21) draws the band into the clamp so it may be tightened around a tooth to be restored. The clamphead (13) includes anatomically curved surfaces that will be more clearly shown in FIG. 3 and subsequent drawings. Attached to the top of the clamphead is a tether (22) which in turn is attached to a C-shaped expansion spring (25), the operation of which will be described in greater detail below. The spring includes flat, spade-like, wedge-shaped tines (27) and is secured to the top of the clamphead (13) by tether (22). The matrix band used with the present procedure is shown in FIG. 2 and is a pre-contoured band (26) well-known in the dental arts. The contour of the band is designed to replicate the natural anatomical contour of a human tooth.

Referring now to FIG. 3, the first step in the procedure of utilizing the present invention is shown. The matrix band (15) is first installed into the clamp (11) which is then fitted around the target tooth (16) and tightened. The clamphead (13) is curved to match the shape of the tooth, in both the vertical and horizontal planes. The bulbous contour of the tooth is therefore accommodated by the structure of the clamphead (13), which is forced against the side of the tooth when the band is tightened. This ensures that the contoured shape of the band is maintained. Although in this illustration only the left side of the clamphead (13) is shown, the opposite right side, which receives the band, is a mirror image thereof and therefore need not be shown separately. The clamphead (13) is symmetrically two-sided to accommodate either right- or left-side engagement as necessary. Once the band is in place, wedges (31) are inserted to achieve firm contact between the band and the surface of the tooth around its base. Expansion spring (25) is attached to the top of the clamphead (13) by tether (22).

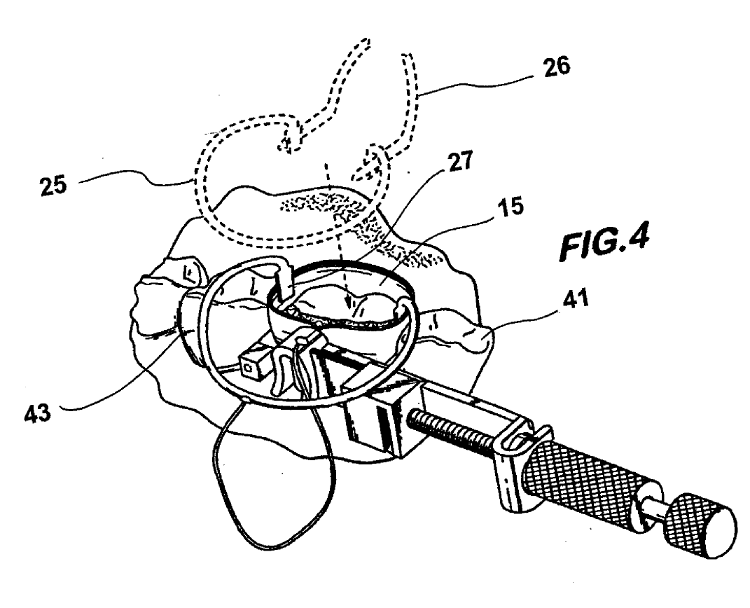

Referring now to FIG. 4, in the next step of the procedure the expansion spring (25), as shown in dotted lines, is inserted from above, preferably using a tweezers or a forceps tool (26), to compress the tines inwardly. Once the spring (25) is installed against opposing inside walls of the matrix band (15), the tines (27) are released and their outward force presses the matrix band firmly against adjacent teeth (41 and 43). This is a key aspect of the invention and results in very tight contact surfaces when non-compacting modern restorative materials are used, as in the present case.

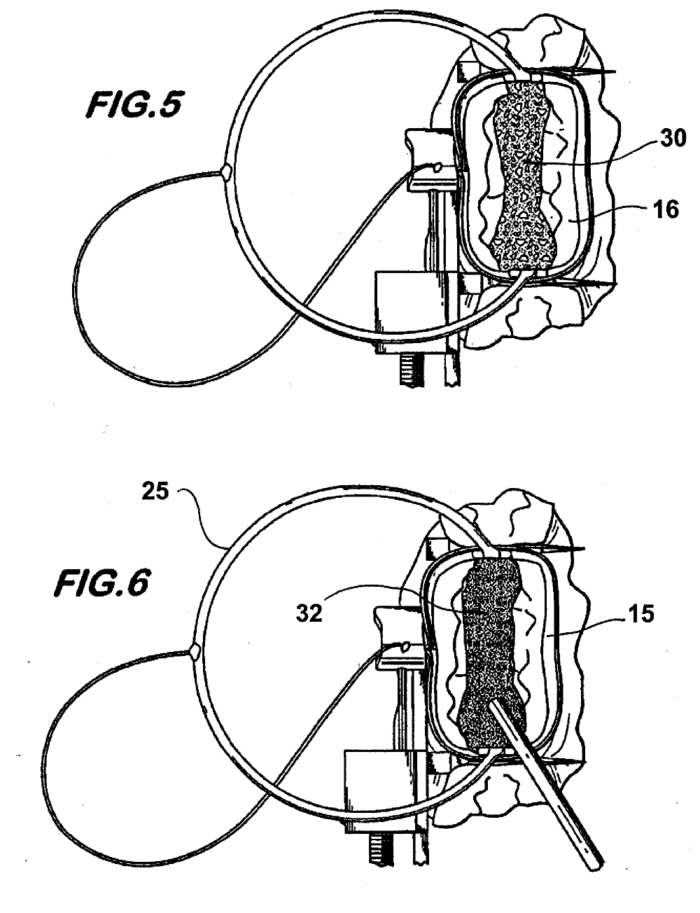

Referring now to FIGS. 5 and 6, the concluding steps in the procedure of applying the restorative material are shown. A preliminary amount of material (30) is first applied to the tooth (16) as shown in FIG. 5 and after a pre-curing step (not shown) a further amount of material (32) is added as shown in FIG. 6. Thereafter, the spring (25) is retracted upwardly from the inside surfaces of the matrix band. The retractability of the spring is facilitated by the tapered wedge shape of the tines. After the spring is removed, any voids left by the tines are filled in with additional material and the restoration process then proceeds in accordance with normal practice (not shown), to be concluded with the final shaping of the tooth and adjustment of the contact surfaces.

It should be understood that there may be other modifications and changes to the present invention that will be obvious to those of skill in the art from the foregoing description, however, the present invention should be limited only by the following claims and their legal equivalents. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by Letters Patent of the United States is:

1. A dental matrix band apparatus for restoring human teeth, comprising;
a clamphead having a head receiving ends of a matrix band for holding a band loop about the outer surface of a human tooth.
means for drawing said matrix band into said clamphead to reduce the length of the band loop and to tighten said band around said tooth; and
first contact surfaces of said clamphead having anatomically contoured surfaces in near abutment with and complementing the shape of said tooth when in use.

2. The apparatus of claim 1 wherein said contact surfaces lie on opposite sides of a slot of said heads through which said matrix band is received.

3. The apparatus of claim 1 wherein said means for drawing said band into said clamphead is a screw slide mechanism.

4. The apparatus of claim 1 further including an expansion spring for applying an outwardly directed force to the inside walls of said band loop.

5. The apparatus of claim 4 wherein said spring includes downward facing tines at ends thereof which engage said band loop.

6. The apparatus of claim 5 wherein said tines are wedge-shaped.

7. The apparatus of claim 6 wherein said spring is attached to the clamp by a tether.

8. The apparatus of claim 7 wherein said tether is flexible.

9. The apparatus of claim 1 wherein said matrix band is pre-contoured.

10. The apparatus of claim 1 wherein alternate contact surfaces are disposed on an opposite side of said clamphead.

11. The apparatus of claim 10 wherein said alternate contact surfaces correspond to the first contact surfaces, being substantially a mirror image thereof.
